(19) United States
(12) Patent Application Publication
(10) Pub. No.: US 2020/0134733 A1
(43) Pub. Date: Apr. 30, 2020

(54) GEOSPATIAL LOCATION-SPECIFIC MODEL FOR PRICING PERILS

(71) Applicant: Intermap Technologies, Inc., Englewood, CO (US)

(72) Inventors: Ivan Maddox, Denver, CO (US); Jan Bednár, Highlands Ranch, CO (US); Jirí Vohlídal, Praha (CZ); Ladislav Garassy, Praha (CZ); Vratislav Tydlitát, Praha (CZ)

(21) Appl. No.: 16/664,696

(22) Filed: Oct. 25, 2019

Related U.S. Application Data
(60) Provisional application No. 62/751,409, filed on Oct. 26, 2018.

(51) Int. Cl. G06Q 40/08; G06K 9/32; G06F 17/18

(52) U.S. Cl. CPC G06Q 40/08; G06F 17/18; G06K 9/3233

(57) ABSTRACT

Disclosed embodiments are directed at geospatial location-specific risk pricing of a peril. The disclosed embodiments can facilitate pricing insurance premiums for various types of perils such as flood, wildfire, volcano, etc. Based on collecting location-specific data of one or more characteristics of the Earth's surface, specific risk scores for a specific location can be derived. The specific risk scores can be processed to determine a premium for the specific location.

### TECHNICAL FIELD

This patent application is directed to risk modeling of perils, and more specifically, to scoring risks associated with floods, wildfires, or other perils, based on location-specific geospatial information.

### BACKGROUND

Currently, assigning insurance premiums to a risk (i.e., rating risk of perils) is done using catastrophe risk models (commonly known as cat models) and their Average Annual Loss (AAL) output. Examples for cat models include those made by AIR Worldwide, RMS, and CoreLogic.

AAL is an estimation of the average loss to be experienced by a specific property or group of properties every year based on stochastic (e.g., Monte Carlo) probabilistic modeling. The AAL can be based upon the specific characteristics of the structure, which result in AAL values being expressed in dollars, or the characteristics can be expressed as normalized values (between 0 and 1) which are then multiplied by the replacement cost of the structure to realize an AAL in dollars.

Flood rates are set by multiplying the AAL for a specific property, in dollars, by a factor between 3 and 6, but typically around 4 to establish the base premium. The final premium is then determined by modifying the base premium with overhead, cost of capital, underwriting credits and debits (for hazard mitigation or amplification), and other miscellaneous credits and debits.

The cat model approach to location-specific flood insurance pricing has several drawbacks. First, cat models, since their inception, have been based on the premise of evaluating large portfolios of locations, and not a single location. The large number of input locations reduce the inherent uncertainty of the statistics. Cat model output on a single location has overwhelming uncertainty and is thus a fundamental misuse of the model.

Second, flood zones are traditionally denoted as frequency (1 in 100 year) or annual probabilities (1% annual probability) to fit into this rating methodology. However, it is impossible to accurately model the annual probability of a flood for a specific location. Flood model accuracy and validation is based upon portfolio analysis with thousands of locations, and there is no way to know the reliability of a flood frequency prediction at a single point.

Third, one of the fundamental requirements of a cat model is to calibrate it with location-specific loss data. In the U.S. there is very limited location-specific flood loss information available. The NFIP (National Flood Insurance Program) has the largest such loss dataset, but federal privacy laws prevent its publication. Meanwhile, in emerging flood insurance markets, there is no loss data to use. Thus, cat models in the U.S. and Asia are uncalibrated for floods, which results in wildly different output from different models. Coincidentally, cat model vendors and users (incorrectly) view this lack of data as a fundamental roadblock to a thriving flood insurance industry.

In light of the foregoing, there is a need for an alternative approach to pricing risks associated with floods, wildfire, or otherwise any other peril, without resorting to cat models, stochastic methodologies, or the resultant AAL output. The disclosed approach of modeling a peril is ideally suited for pricing insurance premiums associated with a peril.

### BRIEF DESCRIPTION OF THE DRAWINGS

The systems and methods described herein may be better understood by referring to the following Detailed Description in conjunction with the accompanying drawings, in which like reference numerals indicate identical or functionally similar elements:

FIG. 1 is a flow diagram showing a method of operation of a processor-based geospatial location-specific flood pricing model according to some implementations of the present technology;

FIG. 2 is a data visualization of representative base flood elevation data for a specific region;

FIG. 3 is a histogram illustrating a distribution of height above base flood elevation for a representative sample of locations and a corresponding table of risk segments;

FIG. 4A is a schematic diagram for deriving a flood risk score for a particular location according to some implementations of the present technology;

FIG. 4B is a set of tables illustrating a representative process for calculating a flood risk score;

FIG. 5 is a histogram illustrating a distribution of derived flood risk scores for a representative sample of locations and a corresponding table of risk segments;

FIG. 6A is a representative table of risk segments and base pricing relative to height above base flood elevation;

FIG. 6B is a representative table of risk segments and base pricing relative to flood risk score;

FIG. 7 is a block diagram illustrating an overview of devices on which some implementations can operate;

FIG. 8 is a block diagram illustrating an overview of an environment in which some implementations can operate; and

FIG. 9 is a block diagram illustrating components which, in some implementations, can be used in a system employing the disclosed technology.

The headings provided herein are for convenience only and do not necessarily affect the scope of the embodiments. Further, the drawings have not necessarily been drawn to scale. For example, the dimensions of some of the elements in the figures may be expanded or reduced to help improve the understanding of the embodiments. Moreover, while the disclosed technology is amenable to various modifications and alternative forms, specific embodiments have been shown by way of example in the drawings and are described in detail below. The intention, however, is not to unnecessarily limit the embodiments described. On the contrary, the embodiments are intended to cover all modifications, combinations, equivalents, and alternatives falling within the scope of this disclosure.

### DETAILED DESCRIPTION

Various examples of the systems and methods introduced above will now be described in further detail. The following description provides specific details for a thorough understanding and enabling description of these examples. One skilled in the relevant art will understand, however, that the techniques and technology discussed herein may be practiced without many of these details. Likewise, one skilled in the relevant art will also understand that the technology can include many other features not described in detail herein. Additionally, some well-known structures or functions may not be shown or described in detail below so as to avoid unnecessarily obscuring the relevant description.

The terminology used below is to be interpreted in its broadest reasonable manner, even though it is being used in conjunction with a detailed description of some specific examples of the embodiments. Indeed, some terms may even be emphasized below; however, any terminology intended to be interpreted in any restricted manner will be overtly and specifically defined as such in this section.

Disclosed herein is an approach to pricing a risk associated with perils. For example, the disclosed approach can be applicable in pricing insurance premiums for perils associated with flood, wildfire, crime, wind, hail, landslide, volcano, or other natural perils. Contrary to conventional methods, the disclosed approach does not use cat models, stochastic methodologies, or the resultant AAL output. Pricing can be established with risk scoring based on location-specific geospatial information, including risk scores, heights above water, and/or heights above flood zones or base flood elevations (BFE). This methodology, not currently employed by any insurance solution provider, is better able to assign premium to risk across an entire market, on a location-specific basis.

For certain types of perils, such as flood, wildfire, crime, wind, hail, landslide, volcano, and others, there is a correlation between location of a property and the risk associated with a peril at that property. For example, a house close to a volcano has a higher volcano risk than a house 1000 miles from the closest volcano. Thus, in accordance with disclosed embodiments, each location is assigned its corresponding premium based on risk information derived from geospatial data, models and analytics that are accurate (with known uncertainty) at that specific location. The disclosed approach minimizes generalizations and does not use statistics dependent upon large samples. Because each location's risk evaluation is performed independently of all other locations, the results of pricing risk for that location are based on the quality of the data used. The disclosed approach is based on accurate and precise geospatial information, especially bare-earth elevation data (Digital Terrain Model (DTM) data) having a high resolution. Accordingly, one advantage of the disclosed approach is that the generated risk pricing model has high accuracy.

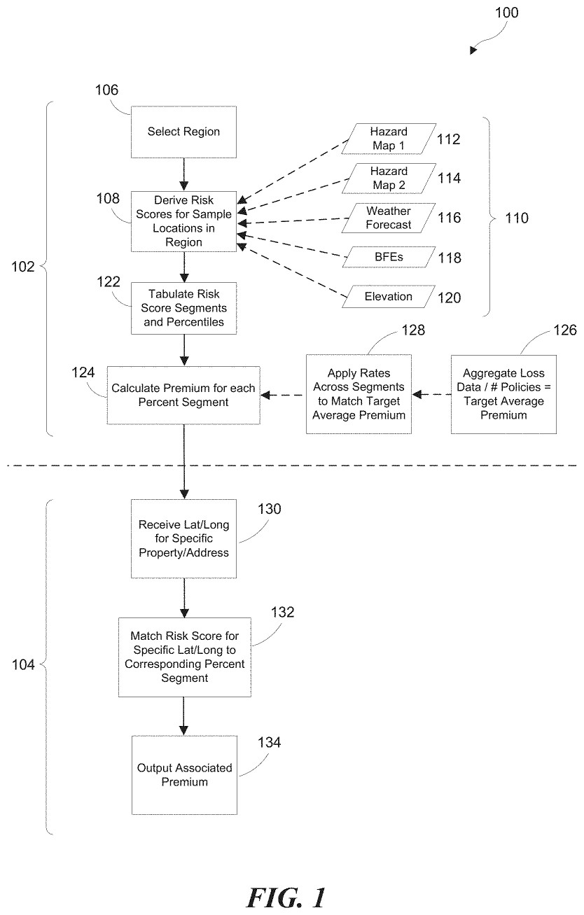

FIG. 1 is a flow diagram showing a representative method of operation 100 of a processor-based geospatial location-specific risk pricing system according to some embodiments of the present technology. The method 100 can include a model setup portion 102 and a specific location risk portion 104. Once the model setup portion 102 of method 100 is completed, the specific location risk portion 104 can be repeated for multiple specific locations to retrieve geospatial location-specific risk information, including premium pricing, for example.

The method starts at 106, where a region of interest, such as a specific flood insurance market, is selected. At 108, risk scores are derived for a statistically significant sample of locations within the selected region or market. These risk scores can be derived from one or more sources of risk information 110 including one or more hazard maps 112 and 114, BFEs 118, and elevation data 120, to name a few. Another source of information that can be included in the assessment of risk is weather forecast information 116. For example, certain available forecasts attempt to predict trends over the coming 12 months that would be relevant to flooding occurrence across a given region (e.g., state-level, country-level).

In some embodiments, risk scores are calculated for more than one location in the statistically significant sample of locations. This is because elevation parameters calculated from the DTM (and/or other supporting datasets) can vary significantly over short distances, causing variability in results. For example, elevation parameters can significantly vary over very short distances between locations, as little as 5 meters apart. As a result, elevation parameters are calculated at multiple locations in the statistically significant sample of locations. In some embodiments, risk scores are calculated for each location included in the statistically significant sample of locations.

In accordance with disclosed embodiments, parameters associated with a future flood event can be predicted before a flood occurs. For example, the DTM of a set of locations can be used to estimate a theoretical water elevation during a flood at one or more locations in the set of locations. The theoretical water elevation during a flood can be calculated by analyzing water flow arising from accumulation of water in catchment basins and subsequent drainage of the accumulated water to larger water bodies such as streams and rivers in its natural course towards the ocean. The DTM can provide ground elevation parameters defining low areas that are likely to fill with water in the likely event of a flood. Thus, at least one advantage of the disclosed technology is in generating likelihood data corresponding to a future flood event. The likelihood data corresponding to a future flood event can be a probability of the flood event at one or more locations in the region. Computing the likelihood data can be based in part on information generated from subtracting the ground elevation parameters from the theoretical water elevation during a flood.

In some embodiments, where DTM is unavailable, elevations of structures at a location can be used to estimate elevation of a location. In some embodiments, Digital Surface Models (DSMs) can be used.

In some embodiments, the most effective predictors of risk are combinations of elevation metrics and flood hazard maps. In some embodiments, a risk score combines at least two measurements, whether modeled or empirical. In some embodiments, risk scoring software, such as InsitePro®, can be used. In other embodiments, a manual process of combining GIS software and spreadsheets can also be used.

Hazard maps can vary in quality. The quality of a hazard map has a direct relationship with the quality of the input data used to create the hazard map. Higher accuracy, higher resolution datasets result in higher quality maps. Therefore, higher quality maps may be more heavily weighted in the risk score calculation process.

In some embodiments, the above risk scores can be relative risk scores. Relative flood risk scores remove the frequency component from the risk assessment by representing the likelihood of a location flooding relative to all the locations around it, assuming the flood happens. By assuming the flood happens, the frequency is thus the 1-year flood zone, or 100% annual probability of flood. Higher scores will flood before lower scores, and experience more severe flooding. Flood scores thus express relative flood risk. Two such relative flood risk scores are available from Intermap Technologies® of Denver, Colo. Specifically, the InsitePro® Flood Risk Score and the height above the InsitePro® BFE are suitable relative flood risk scores.

At 122, the risk scores are tabulated into percentile brackets for multiple risk segments. A relative risk score can be calibrated for a specific region, e.g., the flood insurance market, by using a statistically significant sample of locations of risks within the market. This calibration results in an absolute flood risk score, where an individual risk can be quantified against the entire market. Absolute risk scores can be expressed as percentiles of risk, with 0 percentile being the lowest possible risk, and 100 being the highest. A risk that is in the 33rd percentile means that 33% of risks in the market are lower risk, and 67% are higher risk.

At 124, a premium for each percentile segment can be calculated. With a market-calibrated view of risk, it is possible to calculate rates. The rates can be based upon geospatial information, such as location, proximity to water, local elevations and flood hazard maps, for example. The resulting rates can be base rates, excluding consideration for construction, structural aspects, swimming pools, basements, overhead, capital market status, etc. Those factors can be used to modify the base rate.

The transformation from risk score to rates can use two distinct types of information: industry level data and insurer level information. The industry-level information is aggregated loss data. Unlike location-specific loss data, industry-level aggregated loss data is readily available from reinsurers, reinsurance brokers and advocacy groups. Further, it is often available in convenient segmentations by area and line of business, for example. In some embodiments, this published data can be augmented with similar information provided by users (e.g., insurers). Individual insurers can also provide general information such as geographical areas where they will underwrite flood risk and how much risk they want to take on.

One example of the transformation for scores to rates would be to create a clone of the NFIP. In the U.S., the NFIP publishes total losses by year since there is no privacy concern with the aggregated data. Over the past 40 years, the AAL for the NFIP portfolio (which is predominantly residential) has been $1.627b. This AAL can be factored to determine the total available premium for the market. For example, it can be multiplied by a factor of 4x=$6.5b. At 126, the average premium per policy can then be calculated: the $6.5b is from approximately 5.5 m policies, thus the average premium is ˜$1,180, rounded to $1,200 for ease of arithmetic—a realistic figure in today's market for residential flood cover. That premium is based on a limit of $250 k, so a similar limit would be applied here. Insurers would have flexibility within this methodology to hone the limits and average premium.

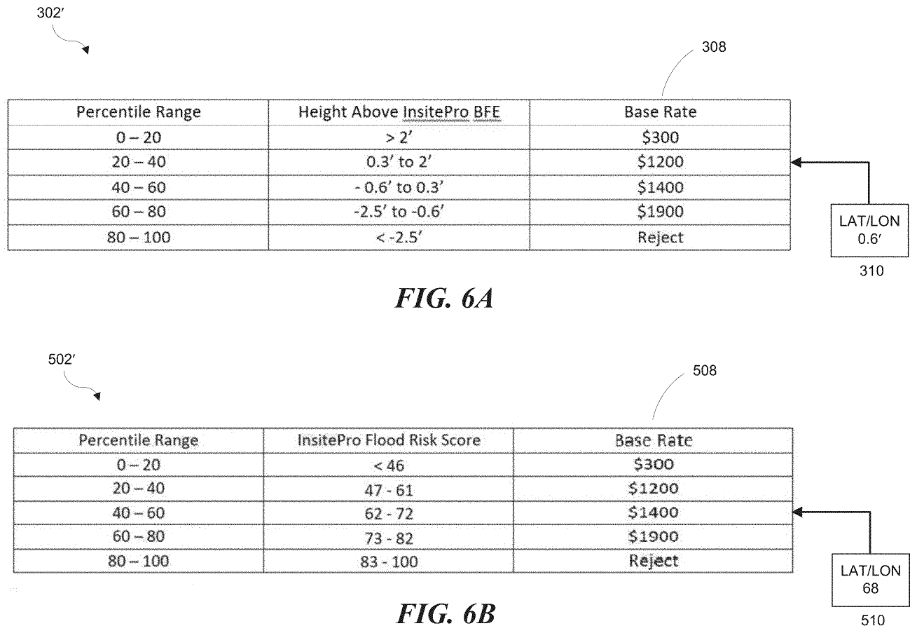

At 128, with the risk segments defined, rates can be applied to each segment so the average premium distributed across the different segments matches the target average premium. At this stage, individual insurers will have flexibility on how they map the base rate onto the percentiles. For example, a straight-line approach can be used, with the 40th percentile corresponding to the average premium ($1,200) and supporting a limit of $250 k (see FIGS. 6A and 6B, for example). Premiums can be added or subtracted based on underwriting criteria, property circumstances, and capital-based variables as defined by the insurer. This modification of the rate is similar to how cat model rates are used. With the above information, the transformation of the absolute risk score to rates can be performed to match with an insurer's business objectives.

Assigning the premium to the risk segments can be done in many ways and can depend on how each insurer prefers to segment the risk. In an embodiment where the insurer does not have a risk appetite bias, the 20th percentile of risk will produce 20% of the available premium, for example.

This methodology can also be used for emerging flood insurance markets where there is little or no historical loss information. The average premium can be defined based on market research (e.g., what the market will support) and ensuring the limits are commensurate with the premium (average premium=˜0.5% of limit). The methodology can be updated as required as the market matures, and losses accumulate.

Once the model setup portion 102 of method 100 is completed for the selected region using industry level data and insurer level information, the user (e.g., insurer) can provide location-specific information at step 130, such as latitude and longitude coordinates (Lat/Long) or an address to retrieve a location-specific premium. Once the latitude and longitude are received for the specific address at 130, the risk score for the specific latitude and longitude can be matched with the corresponding percentile segment at 132, and the associated premium can be output to the insurer at 134. The results (e.g., premium and/or risk score) can be delivered to the user through an API or a user interface, for example.

For some types of perils, such as wildfire, other types of data can be used. An example of the data can be vegetation data. The vegetation data can include a proximity of a location (among locations in a region of interest) to vegetation, the moisture content of that vegetation, the species of the vegetation, and the proclivity/probability of the vegetation to be flammable (i.e., burn or produce embers).

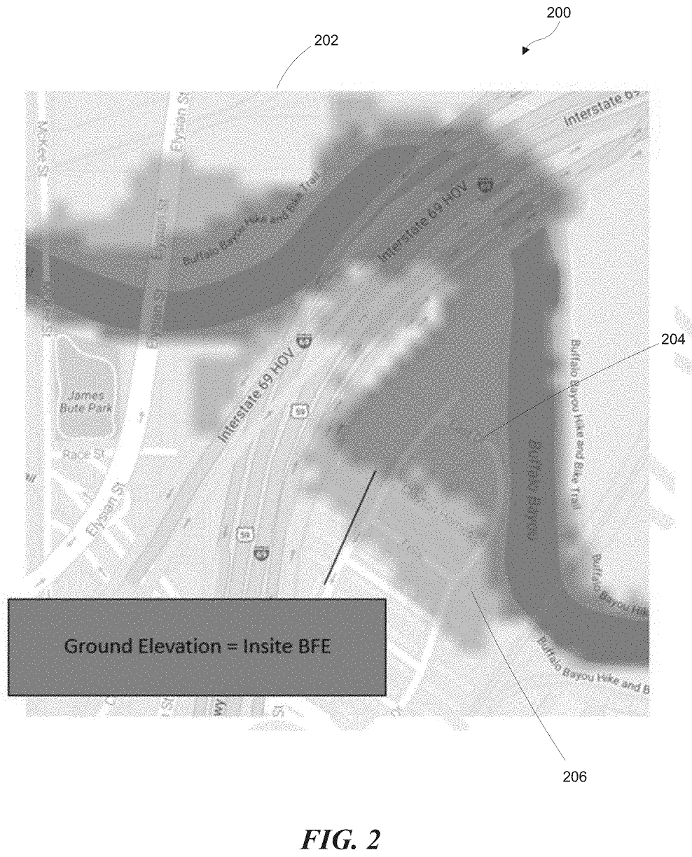

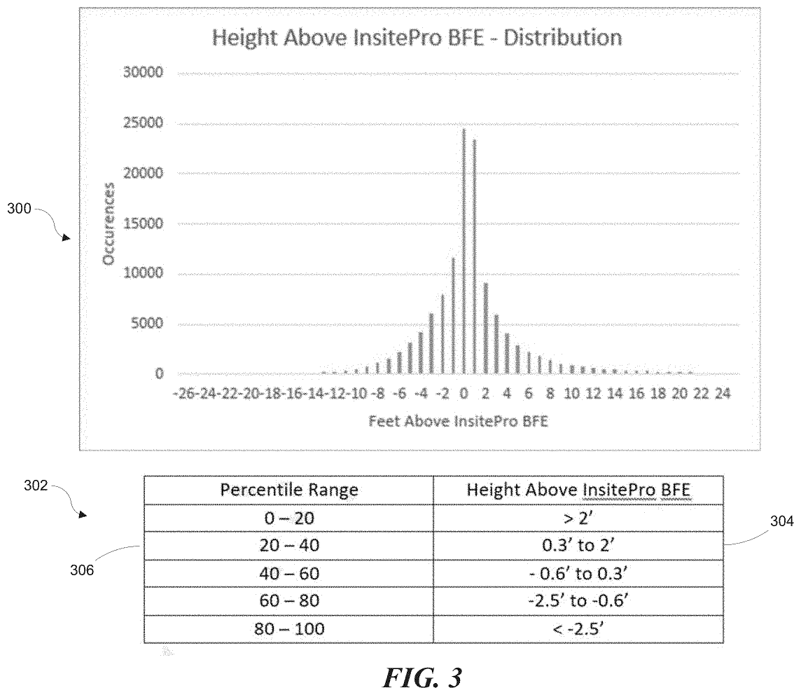

FIGS. 2 and 3 each illustrate a representative example of using the height above the InsitePro® BFE for steps 106, 108, and 122 described above. FIG. 2 is a data visualization 200 of representative BFE data for a specific region 202. The InsitePro® BFE is the elevation of the FEMA Special Flood Hazard Area (SFHA, comprised of A and V zones 206 and 204, respectively) at the point closest to the risk being evaluated.

FIG. 3 is a histogram 300 illustrating a distribution of height above the InsitePro® BFE for a representative sample including 123,000 residential locations of in-force flood policies. Risk table 302 includes five distinct risk segments corresponding to the data plotted in histogram 300. Each percentile range 306 corresponds to a range of heights 304 above InsitePro® BFE.

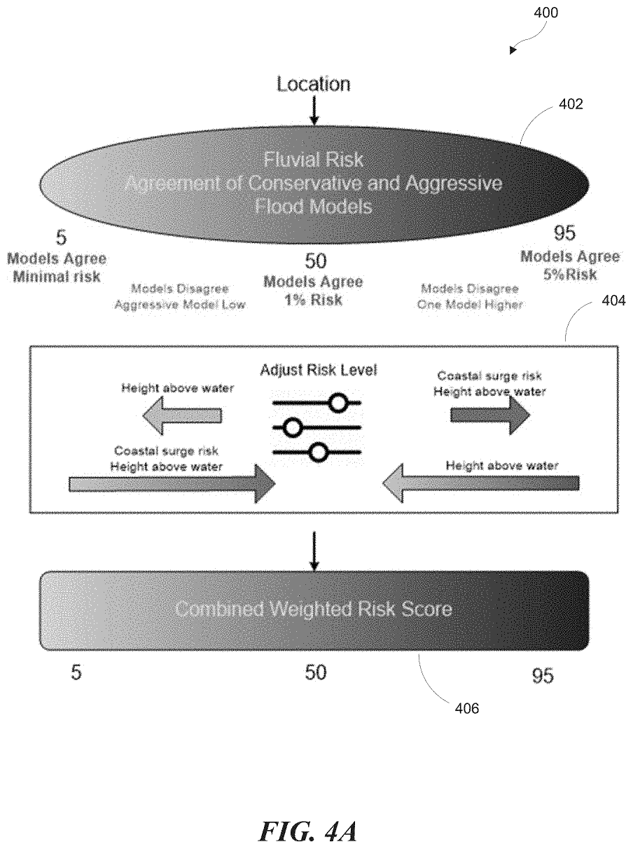

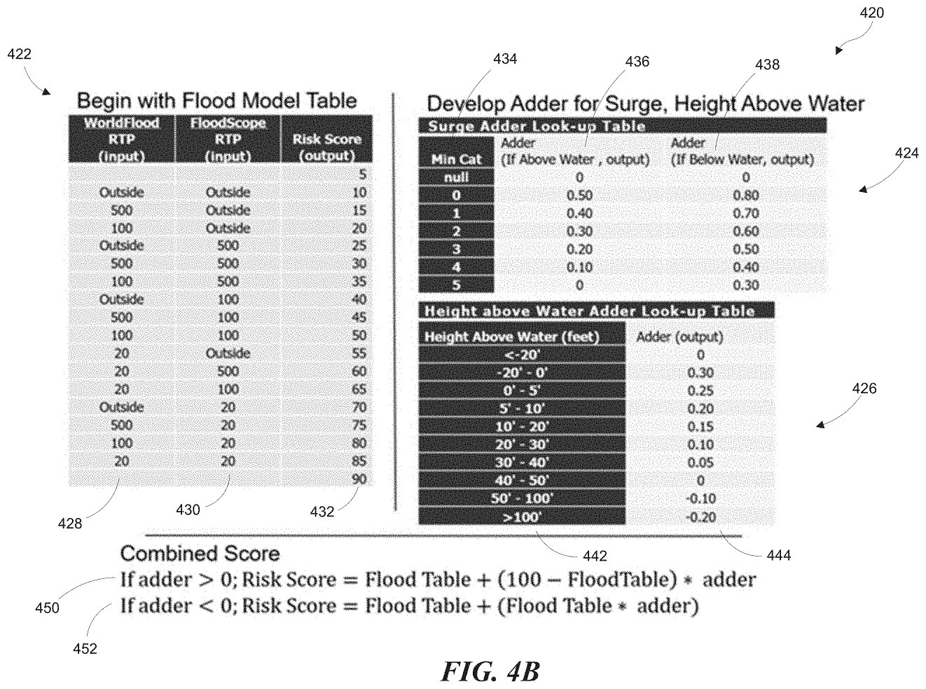

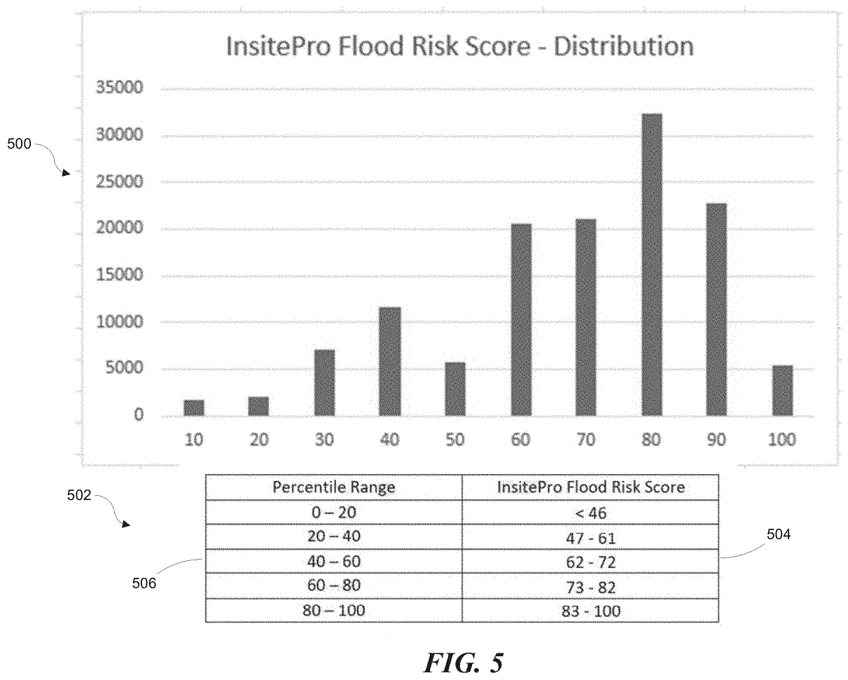

FIGS. 4A-5 each illustrate a representative example of using the InsitePro® Flood Risk Score for steps 106, 108, and 122 described above. FIG. 4A is a schematic diagram illustrating a process 400 for deriving a flood risk score for a particular location. This flood risk score is derived by combining (e.g., via a weighted average) the output of multiple flood pricing models at 402, which can range in risk evaluation from aggressive to conservative. In some embodiments, suitable flood pricing models can include Intermap®s WorldFlood and FloodScope flood models as well as the NFIP Flood Insurance Rate Maps (FIRMS), for example. Intermap®'s FloodScope model is described in U.S. Pat. No. 10,147,057, filed Aug. 13, 2015, the disclosure of which is incorporated herein by reference in its entirety. The weighting 404 of the models can be adjusted based on which models agree and by how much they differ. The weighting can also be adjusted based on height above water and coastal surge risks. The combined weighted risk score 406 can range from 0 to 100 corresponding to minimum and maximum risk, respectively.

FIG. 4B illustrates a representative set of tables 420 for calculating a combined flood risk score at 402 (FIG. 4A). The process begins with Flood Model Table 422. In this example, the particular location of interest is evaluated with both WorldFlood and FloodScope models to determine a Return Time Period (RTP) 428, 430 from each model. The RTP corresponds to 20, 100, and 500 year floods and areas outside the 500 year zone. A base risk score 432 is assigned to each combination of model outputs on a scale between 0 and 100. For example, when WorldFlood returns a 100 year RTP and FloodScope returns a 500 year RTP, the base risk score is 35. In some embodiments, deference can be given to one model over the other. For example, as shown in table 422, deference is given to the FloodScope model.

Once a base risk score 432 is determined, the score can be adjusted at 404 (FIG. 4A) using surge zone and height above water adder tables 424 and 426, respectively. Using surge zone table 424, the surge adder is selected based on the location's surge zone 434 (e.g., hurricane category) and whether the location is above 436 or below 438 the nearest water (i.e., source of flooding). For example, for a location in a Cat 2 surge zone and located above the water table returns a 0.30 adder factor. Using formulas 450 and 452, as appropriate, the base risk score can be adjusted using the surge adder factors 436/438. For example, the calculations for a location having a WorldFlood RTP of 100, a FloodScope RTP of 500, located in a Cat 2 surge zone, and is six feet above the nearest water is as follows:

Risk Score=35+(100−35)*0.30=54.5

This adjusted risk score can be further adjusted based on the location's height above water 442 using the height above water adder look-up table 426 and formula 450. In the example above, the location is 6 feet above the nearest water which corresponds to an adder 444 of 0.20. Beginning with the surge adjusted risk score the new risk score is calculated as follows:

Risk Score=54.5+(100−54.5)*0.20=63.6

As another example, the calculations for a location having a WorldFlood RTP of 100, a FloodScope RTP of outside, located in a Cat 2 surge zone, and is 55 feet above the nearest water is as follows:

Risk Score=20+(100−20)*0.30=44

Risk Score=44+(44*−0.10)=39.6

In this example, the adder 444 for height above water is −0.10; therefore, formula 452 is used to adjust the risk score.

FIG. 5 is a histogram 500 illustrating a distribution of InsitePro® Flood Risk Scores for a representative sample including 123,000 residential locations of in-force flood policies. Risk table 502 includes five distinct risk segments corresponding to the data plotted in histogram 500. Each percentile range 506 corresponds to a range of risk scores 504.

The methodologies described above with respect to height above the InsitePro® BFE and InsitePro® Flood Risk Scores each allow flexibility on how the risk is segmented. For example, the low risk segment (0-20 percentile) could be further segmented to create even more refined rating options.

FIGS. 6A and 6B illustrate risk tables 302′ and 502′ with associated base rates 308 and 508 added to each percentile range according to step 124 described above with respect to FIG. 1. In the example depicted in FIG. 6A, the user has entered, at step 130 (FIG. 1), a Lab/Long 310 corresponding to a height above an InsitePro® BFE of 0.6 feet. This height can be matched, at step 132, to percentile segment 20-40 and an associated base premium or rate of $1,200.

In the example depicted in FIG. 6B, the user has entered, at step 130 (FIG. 1), a Lat/Long 510 corresponding to an InsitePro® Flood Risk Score of 68. This score can be matched, at step 132, to percentile segment 40-60 and an associated base premium or rate of $1,400.

The technology described herein provides various advantages over existing systems and methods of assigning risk. For example, the customization of rate calculations can provide an insurer the opportunity to gain a competitive edge over its competition that is not available to cat model users because those models are calibrated once and deliver the same results to all users.

Risk selection and rating based on location-specific risk scores results in a more profitable and claims-averse portfolio. The rating is based on empirical elements that are specific for each risk as it is underwritten. Cat model AALs are not based on empirical information at the point of underwriting: AALs are based upon a single flood hazard map and chance (i.e., Monte Carlo).

Underwriting with risk scores can improve the usefulness of cat models by providing a risk assessment at the point of underwriting that is independent of the cat model that will estimate the portfolio-level losses. Using the same cat model for underwriting and portfolio loss estimation magnifies any under or overestimation of a specific risk.

Location-specific risk scores benefit from the use of high quality geospatial data because there is no generalization of risk measurements. Since each location's risk is determined based on data for that specific point, the results are particularly robust if the resolution and accuracy of the data are better than building level. Single point output from cat models is more uncertain because the models leverage lower quality geospatial information as they generalize risk over broad areas and thousands of risks.

The present technology has been described in the context of providing a premium or rate in dollars because that is the ultimate format needed by underwriters, and monetary output can be delivered with this methodology because the rating is calibrated with industry-level loss information expressed in dollars. However, other outputs are possible. For example, risk can be expressed as a coefficient/ratio by estimating the total insured value (TIV) of the insured property. The ratio of losses to TIV can then be applied to the premium derived as explained above, and then applied to the value of specific properties being underwritten.

Although the present technology has been described in the context of flood risk, insurance rates for other natural catastrophe risks can be set with the disclosed techniques. For example, the risk of wildfire, like flood risk, is dependent upon precise location information and geospatial datasets, which lends this type of risk to the disclosed systems and methods.

In some embodiments, a geospatial location-specific risk pricing system can comprise an aerial sensor configured to collect one or more characteristics of the Earth's surface and at least one memory device; the memory device having or storing instructions for causing at least one processor to: receive information defining a region of interest; derive a risk score for each of the multiple sample locations in the region based at least in part on the one or more characteristics of the Earth's surface; tabulate the risk scores into multiple percentile segments; calculate a premium for each of the percentile segments, whereby the premiums are applied across the percentile segments to result in a target average premium; receive information related to a specific location of interest within the region; derive a specific risk score for the specific location; match the specific risk score to a corresponding one of the multiple percentile segments; and output the premium associated with the corresponding one of the multiple percentile segments.

In some embodiments, the one or more characteristics of the Earth's surface comprises elevation data. In some embodiments, the elevation data comprises Digital Terrain Model (DTM) data. In some embodiments, the target average premium comprises an aggregate loss value for the region divided by a number of insurance policies in the region. In some embodiments, the risk scores are related to flood risk. In some embodiments, the risk scores are related to wildfire risk.

### Suitable System

The techniques disclosed here can be embodied as special-purpose hardware (e.g., circuitry), as programmable circuitry appropriately programmed with software and/or firmware, or as a combination of special-purpose and programmable circuitry. Hence, embodiments may include a machine-readable medium having stored thereon instructions which may be used to cause a computer, a microprocessor, processor, and/or microcontroller (or other electronic devices) to perform a process. The machine-readable medium may include, but is not limited to, optical discs, compact disc read-only memories (CD-ROMs), magneto-optical disks, ROMs, random access memories (RAMS), erasable programmable read-only memories (EPROMs), electrically erasable programmable read-only memories (EEPROMs), magnetic or optical cards, flash memory, or other type of media/machine-readable medium suitable for storing electronic instructions.

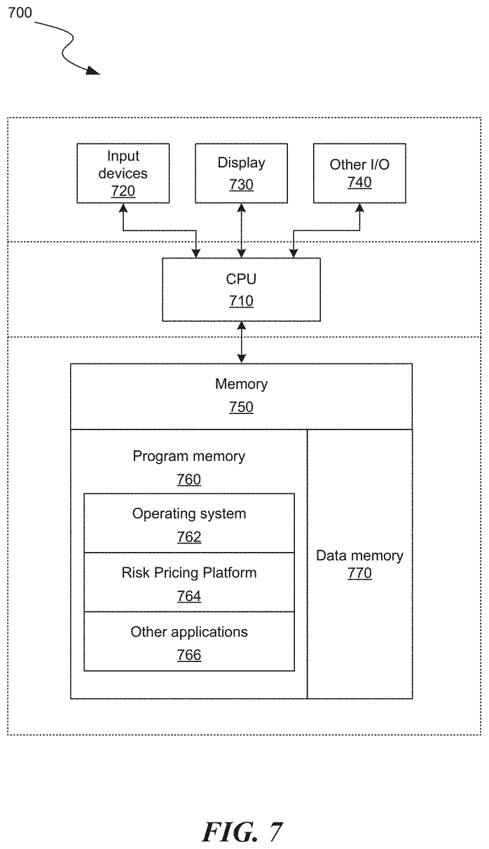

Several implementations are discussed below in more detail in reference to the figures. FIG. 7 is a block diagram illustrating an overview of devices on which some implementations of the disclosed technology can operate. The devices can comprise hardware components of a device 700 that determines risk scores and associated pricing and/or risk ratios. Device 700 can include one or more input devices 720 that provide input to the CPU (processor) 710, notifying it of actions. The actions are typically mediated by a hardware controller that interprets the signals received from the input device and communicates the information to the CPU 710 using a communication protocol. Input devices 720 include, for example, a mouse, a keyboard, a touchscreen, an infrared sensor, a touchpad, a wearable input device, a camera- or image-based input device, a microphone, or other user input devices.

CPU 710 can be a single processing unit or multiple processing units in a device or distributed across multiple devices. CPU 710 can be coupled to other hardware devices, for example, with the use of a bus, such as a PCI bus or SCSI bus. The CPU 710 can communicate with a hardware controller for devices, such as for a display 730. Display 730 can be used to display text and graphics. In some examples, display 730 provides graphical and textual visual feedback to a user. In some implementations, display 730 includes the input device as part of the display, such as when the input device is a touchscreen or is equipped with an eye direction monitoring system. In some implementations, the display is separate from the input device. Examples of display devices are: an LCD display screen; an LED display screen; a projected, holographic, or augmented reality display (such as a heads-up display device or a head-mounted device); and so on. Other I/O devices 740 can also be coupled to the processor, such as a network card, video card, audio card, USB, FireWire or other external device, camera, printer, speakers, CD-ROM drive, DVD drive, disk drive, or Blu-Ray device. Moreover, data can be collected from various devices such as aerial (e.g., aircraft or drone) sensors, including cameras, X-band interferometric synthetic aperture radar (IFSAR), P-band SAR, synthetic aperture radar (SAR), and Light Detection and Ranging (LIDAR).

In some implementations, the device 700 also includes a communication device capable of communicating wirelessly or wire-based with a network node. The communication device can communicate with another device or a server through a network using, for example, TCP/IP protocols. Device 700 can utilize the communication device to distribute operations across multiple network devices.

The CPU 710 can have access to a memory 750. A memory includes one or more of various hardware devices for volatile and non-volatile storage and can include both read-only and writable memory. For example, a memory can comprise random access memory (RAM), CPU registers, read-only memory (ROM), and writable non-volatile memory, such as flash memory, hard drives, floppy disks, CDs, DVDs, magnetic storage devices, tape drives, device buffers, and so forth. A memory is not a propagating signal divorced from underlying hardware; a memory is thus non-transitory. Memory 750 can include program memory 760 that stores programs and software, such as an operating system 762, Risk Scoring and Pricing Platform 764, and other application programs 766. Memory 750 can also include data memory 770 that can include a selected region, a particular latitude and longitude, etc., which can be provided to the program memory 760 or any element of the device 700. In some embodiments, the risk pricing platform can be provided as a cloud-based remote service, or on-premises server-based service. In some embodiments, a third party can provide risk pricing separate from the system.

Some implementations can be operational with numerous other general purpose or special purpose computing system environments or configurations. Examples of well-known computing systems, environments, and/or configurations that may be suitable for use with the technology include, but are not limited to, personal computers, server computers, handheld or laptop devices, cellular telephones, mobile phones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

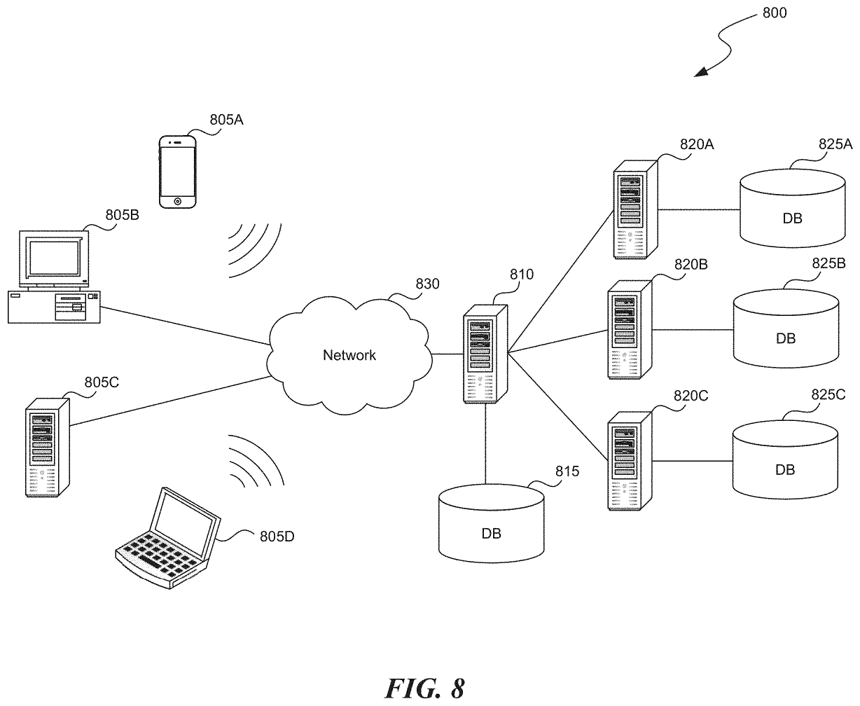

FIG. 8 is a block diagram illustrating an overview of an environment 800 in which some implementations of the disclosed technology can operate, Environment 800 can include one or more client computing devices 805A-D, examples of which can include device 700. Client computing devices 805 can operate in a networked environment using logical connections through network 830 to one or more remote computers, such as a server computing device 810.

In some implementations, server computing device 810 can be an edge server that receives client requests and coordinates fulfillment of those requests through other servers, such as servers 820A-C. Server computing devices 810 and 820 can comprise computing systems, such as device 700. Though each server computing device 810 and 820 is displayed logically as a single server, server computing devices can each be a distributed computing environment encompassing multiple computing devices located at the same or at geographically disparate physical locations. In some implementations, each server computing device 820 corresponds to a group of servers.

Client computing devices 805 and server computing devices 810 and 820 can each act as a server or client to other server/client devices. Server 810 can connect to a database 815. Servers 820A-C can each connect to a corresponding database 825A-C. As discussed above, each server 820 can correspond to a group of servers, and each of these servers can share a database or can have their own database. Databases 815 and 825 can warehouse (e.g., store) information such as selected region information, a particular latitude and longitude location information, resulting risk scores, pricing/risk ratios, and/or user preferences. Though databases 815 and 825 are displayed logically as single units, databases 815 and 825 can each be a distributed computing environment encompassing multiple computing devices, can be located within their corresponding server, or can be located at the same or at geographically disparate physical locations.

Network 830 can be a local area network (LAN) or a wide area network (WAN), but can also be other wired or wireless networks. Network 830 may be the Internet or some other public or private network. Client computing devices 805 can be connected to network 830 through a network interface, such as by wired or wireless communication. While the connections between server 810 and servers 820 are shown as separate connections, these connections can be any kind of local, wide area, wired, or wireless network, including network 830 or a separate public or private network.

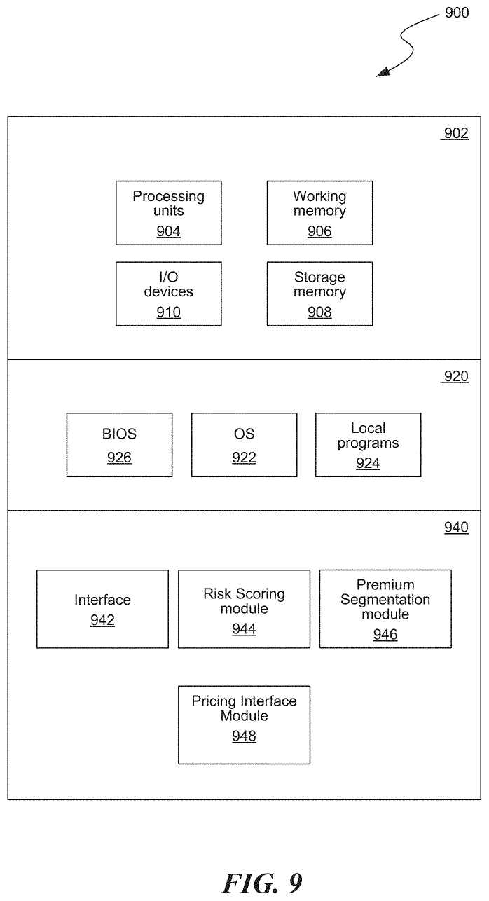

FIG. 9 is a block diagram illustrating components 900 which, in some implementations, can be used in a system employing the disclosed technology. The components 900 include hardware 902, general software 920, and specialized components 940. As discussed above, a system implementing the disclosed technology can use various hardware, including processing units 904 (e.g., CPUs, GPUs, APUs, etc.), working memory 906, storage memory 908, and input and output devices 910. Components 900 can be implemented in a client computing device such as client computing devices 805 or on a server computing device, such as server computing device 810 or 820.

General software 920 can include various applications, including an operating system 922, local programs 924, and a basic input output system (BIOS) 926. Specialized components 940 can be subcomponents of a general software application 920, such as local programs 924. Specialized components 940 can include Risk Scoring Module 944, Premium Segmentation module 946, Pricing Interface module 948, and components that can be used for transferring data and controlling the specialized components, such as interface 942. In some implementations, components 900 can be in a computing system that is distributed across multiple computing devices or can be an interface to a server-based application executing one or more of specialized components 940.

Those skilled in the art will appreciate that the components illustrated in FIGS. 7-9 described above, and in each of the flow diagrams discussed above, may be altered in a variety of ways. For example, the order of the logic may be rearranged, sub steps may be performed in parallel, illustrated logic may be omitted; other logic may be included, etc. In some implementations, one or more of the components described above can execute one or more of the processes described below.

### Remarks

The above description and drawings are illustrative and are not to be construed as limiting. Numerous specific details are described to provide a thorough understanding of the disclosure. However, in some instances, well-known details are not described in order to avoid obscuring the description. Further, various modifications may be made without deviating from the scope of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. It will be appreciated that the same thing can be said in more than one way. Consequently, alternative language and synonyms may be used for any one or more of the terms discussed herein, and any special significance is not to be placed upon whether or not a term is elaborated or discussed herein. Synonyms for some terms are provided. A recital of one or more synonyms does not exclude the use of other synonyms. The use of examples anywhere in this specification, including examples of any term discussed herein, is illustrative only and is not intended to further limit the scope and meaning of the disclosure or of any exemplified term. Likewise, the disclosure is not limited to various embodiments given in this specification, Unless otherwise defined, all technical and scientific terms used herein have the same meaning as commonly understood by one of ordinary skill in the art to which this disclosure pertains. In the case of conflict, the present document, including definitions, will control,

What is claimed is:

1. A geospatial location-specific risk pricing system, comprising:
an aerial sensor configured to collect one or more characteristics of the Earth's surface;
at least one memory device storing instructions for causing at least one processor to:
receive information defining a region of interest;
derive a risk score for each of multiple sample locations in the region based at least in part on the one or more characteristics of the Earth's surface;
tabulate the risk scores into multiple percentile segments;
calculate a premium for each of the percentile segments, whereby the premiums are applied across the percentile segments to result in a target average premium;
receive information related to a specific location of interest within the region;
derive a specific risk score for the specific location;
match the specific risk score to a corresponding one of the multiple percentile segments; and
output the premium associated with the corresponding one of the multiple percentile segments.

2. The system of claim 1, wherein the one or more characteristics of the Earth's surface comprises elevation data.

3. The system of claim 2, wherein the elevation data comprises Digital Terrain Model (DTM) data.

4. The system of claim 1, wherein the target average premium comprises an aggregate loss value for the region divided by a number of insurance policies in the region.

5. The system of claim 1, wherein the risk scores are related to flood risk.

6. The system of claim 1, wherein the risk scores are related to wildfire risk.

7. The system of claim 1, wherein deriving the specific risk score for the specific location includes:
estimating, using the one or more characteristics of the Earth's surface at the multiple sample locations in the region, information defining a water elevation associated with a flood event; and
generating, based at least in part on the information defining the water elevation, likelihood data corresponding to the flood event.

8. The system of claim 7, wherein the likelihood data corresponding to the flood event includes a probability of the flood event at the specific location.

9. A method for geospatial location-specific risk pricing of a peril, the method comprising:
collecting, using an aerial sensor, one or more characteristics of the Earth's surface;
receiving information defining a region of interest;
deriving a risk score for each of multiple sample locations in the region based at least in part on the one or more characteristics of the Earth's surface;
tabulating the risk scores into multiple percentile segments;
calculating a premium for each of the percentile segments, whereby the premiums are applied across the percentile segments to result in a target average premium;
receiving information related to a specific location of interest within the region;
deriving a specific risk score for the specific location;
matching the specific risk score to a corresponding one of the multiple percentile segments; and
outputting the premium associated with the corresponding one of the multiple percentile segments.

10. The method of claim 9, wherein the one or more characteristics of the Earth's surface comprises elevation data.

11. The method of claim 10, wherein the elevation data comprises Digital Terrain Model (DTM) data.

12. The method of claim 9, wherein the target average premium comprises an aggregate loss value for the region divided by a number of insurance policies in the region.

13. The method of claim 9, wherein the risk scores are related to flood risk.

14. The system of claim 9, wherein the risk scores are related to wildfire risk.

15. The method of claim 9, wherein deriving the specific risk score for the specific location includes:
estimating, using the one or more characteristics of the Earth's surface at the multiple sample locations in the region, information defining a water elevation associated with a flood event; and
generating, based at least in part on the information defining the water elevation, likelihood data corresponding to the flood event.

16. The method of claim 9, wherein the likelihood data corresponding to the flood event includes a probability of the flood event at the specific location.

17. A non-transitory computer-readable storage medium storing instructions that, when executed by a computing system, cause the computing system to perform operations for geospatial location-specific risk pricing of a peril, the operations comprising:
collecting, using an aerial sensor, one or more characteristics of the Earth's surface;
receiving information defining a region of interest;
deriving a risk score for each of multiple sample locations in the region based at least in part on digital models generated from the one or more characteristics of the Earth's surface;
tabulating the risk scores into multiple percentile segments;
calculating a premium for each of the percentile segments, whereby the premiums are applied across the percentile segments to result in a target average premium; and
receiving information related to a specific location of interest within the region;
deriving a specific risk score for the specific location;
matching the specific risk score to a corresponding one of the multiple percentile segments; and
outputting the premium associated with the corresponding one of the multiple percentile segments.

18. The computer-readable storage medium of claim 17, wherein the target average premium comprises an aggregate loss value for the region divided by a number of insurance policies in the region.

19. The computer-readable storage medium of claim 17, wherein deriving the specific risk score for the specific location includes:
estimating, using the one or more characteristics of the Earth's surface at the multiple sample locations in the region, information defining a water elevation associated with a flood event; and
generating, based at least in part on the information defining the water elevation, likelihood data corresponding to the flood event.

20. The computer-readable storage medium of claim 17, wherein the likelihood data corresponding to the flood event includes a probability of the flood event at the specific location.
